(19) United States
(12) Patent Application Publication
(10) Pub. No.: US 2019/0130896 A1
(43) Pub. Date: May 2, 2019

(54) Regularization Techniques for End-To-End Speech Recognition

(71) Applicant: salesforce.com, inc., San Francisco, CA (US)

(72) Inventors: Yingbo ZHOU, San Jose, CA (US); Caiming XIONG, Palo Alto, CA (US); Richard SOCHER, Menlo Park, CA (US)

(73) Assignee: salesforce.com, inc., San Francisco, CA (US)

(21) Appl. No.: 15/851,579

(22) Filed: Dec. 21, 2017

Related U.S. Application Data
(60) Provisional application No. 62/577,710, filed on Oct. 26, 2017.
(60) Provisional application No. 62/578,366, filed on Oct. 27, 2017.
(60) Provisional application No. 62/578,369, filed on Oct. 27, 2017.

(51) Int. Cl. G10L 15/06; G10L 15/24; G10L 13/033; G10L 13/04; G10L 15/20

(52) U.S. Cl. CPC G10L 15/063; G10L 15/24; G10L 2015/0631; G10L 13/043; G10L 15/20; G10L 13/0335

(57) ABSTRACT

The disclosed technology teaches regularizing a deep end-to-end speech recognition model to reduce overfitting and improve generalization: synthesizing sample speech variations on original speech samples labelled with text transcriptions, and modifying a particular original speech sample to independently vary tempo and pitch of the original speech sample while retaining the labelled text transcription of the original speech sample, thereby producing multiple sample speech variations having multiple degrees of variation from the original speech sample. The disclosed technology includes training a deep end-to-end speech recognition model, on thousands to millions of original speech samples and the sample speech variations on the original speech samples, that outputs recognized text transcriptions corresponding to speech detected in the original speech samples and the sample speech variations. Additional sample speech variations include augmented volume, temporal alignment offsets and the addition of pseudo-random noise to the particular original speech sample.

### RELATED APPLICATIONS

This application claims the benefit of U.S. Provisional Application No. 62/577,710, entitled “REGULARIZATION TECHNIQUES FOR END-TO-END SPEECH RECOGNITION”, (Atty. Docket No. SALE 1201-1/3264PROV), filed Oct. 26, 2017. The related application is hereby incorporated by reference herein for all purposes.

This application claims the benefit of U.S. Provisional Application No. 62/578,366, entitled “DEEP LEARNING-BASED NEURAL NETWORK, ARCHITECTURE, FRAMEWORKS AND ALGORITHMS”, (Atty. Docket No. SALE 1201A/3270PROV), filed Oct. 27, 2017. The related application is hereby incorporated by reference herein for all purposes.

### FIELD OF THE TECHNOLOGY DISCLOSED

The technology disclosed relates generally to the regularization effectiveness of data augmentation and dropout for deep neural network based, end-to-end speech recognition models for automated speech recognition (ASR).

### BACKGROUND

The subject matter discussed in this section should not be assumed to be prior art merely as a result of its mention in this section. Similarly, a problem mentioned in this section or associated with the subject matter provided as background should not be assumed to have been previously recognized in the prior art. The subject matter in this section merely represents different approaches, which in and of themselves may also correspond to implementations of the claimed technology.

Vocal length perturbation (VLTP) is a popular method for doing feature level data augmentation in speech. However, data level augmentation, which augments raw audio, is more flexible than feature level augmentation due to the absence of feature level dependencies. For example, augmentation by adjusting the speed of the audio will result in changes in both pitch and tempo of that audio signal: since the pitch is positively related with speed, it is not possible to generate audio with higher pitch but slower speed and vice versa. This may not be ideal since it reduces the number of independent variations in augmented data for training the speech recognition model, which in turn may hurt performance.

Therefore, an opportunity arises to increase the variation in the generation of the synthetic training data set, by separating speed perturbation into two independent components—tempo and pitch. By keeping the pitch and tempo separate, a wider range of variations are covered by the generated data. The disclosed systems and methods make it possible to achieve a new state-of-the art word error rate for the deep end-to-end speech recognition model.

### SUMMARY

A simplified summary is provided herein to help enable a basic or general understanding of various aspects of exemplary, non-limiting implementations that follow in the more detailed description and the accompanying drawings. This summary is not intended, however, as an extensive or exhaustive overview. Instead, the sole purpose of the summary is to present some concepts related to some exemplary non-limiting implementations in a simplified form as a prelude to the more detailed description of the various implementations that follow.

The disclosed technology regularizes a deep end-to-end speech recognition model to reduce overfitting and improve generalization. A disclosed method includes synthesized sample speech samples from the original speech samples including labelled audio samples matched with text transcriptions. The synthesizing includes modifying a particular original speech sample to independently vary tempo and pitch of the original speech sample while retaining labeling with the text transcription, thereby producing multiple speech variations having multiple degrees of variation from the original speech sample and labelled with the text transcription of the original speech sample. The disclosed method also includes training a deep end-to-end speech recognition model, on the original speech samples and the sample speech variations obtained from the original speech samples, in one thousand to millions of backward propagation iterations, so that the deep end-to-end speech recognition model outputs recognized text transcriptions corresponding to speech detected.

Further sample speech variations can include synthesizing sample speech variations by further modifying the particular original speech sample to vary its volume, independently of varying the tempo and the pitch, and by applying temporal alignment offsets to the particular original speech sample, producing additional sample speech variations from the particular original speech sample and having the labelled text transcription of the original speech sample. Another disclosed variation can include a shift of the alignment between the original speech sample and the sample speech variation with temporal alignment offset of zero milliseconds to ten milliseconds. Some implementations of the disclosed method also include synthesizing sample speech variations by applying pseudo-random noise to the particular original speech sample, producing additional sample speech variations. In some implementations, the pseudo-random noise is generated from recordings of sound and combined with the original speech sample as random background noise.

Other aspects and advantages of the technology disclosed can be seen on review of the drawings, the detailed description and the claims, which follow.

### BRIEF DESCRIPTION OF THE DRAWINGS

The patent or application file contains at least one drawing executed in color. Copies of this patent or patent application publication with color drawing(s) will be provided by the Office upon request and payment of the necessary fee. The color drawings also may be available in PAIR via the Supplemental Content tab.

In the drawings, like reference characters generally refer to like parts throughout the different views. Also, the drawings are not necessarily to scale, with an emphasis instead generally being placed upon illustrating the principles of the technology disclosed. In the following description, various implementations of the technology disclosed are described with reference to the following drawings, in which:

FIG. 1 depicts an exemplary system for data augmentation and dropout for training a deep neural network based, end-to-end speech recognition model.

FIG. 2, FIG. 3 and FIG. 4 illustrate a block diagram for the data augmenter included in the exemplary system depicted in FIG. 1, with example input data and augmented data, according to one implementation of the technology disclosed.

FIG. 5A shows a block diagram for processing augmented inputs to generate normalized input speech data.

FIG. 5B shows the speech spectrogram for the example original speech example sentence.

FIG. 5C shows the speech spectrogram for the pitch-perturbed example original speech.

FIG. 5D shows the speech spectrogram for the tempo-perturbed example original speech.

FIG. 6A shows the example speech spectrogram for the original speech example sentence as shown in FIG. 5B, for comparison with FIG. 6B, FIG. 6C and FIG. 6D.

FIG. 6B shows the speech spectrogram for a volume-perturbed original speech example sentence.

FIG. 6C shows the speech spectrogram for a temporally shifted example original speech sentence.

FIG. 6D shows a speech spectrogram for a noise-augmented example original speech.

FIG. 7 shows a block diagram for the model for normalized input speech data and the deep end-to-end speech recognition, and for training, in accordance with one or more implementations of the technology disclosed.

FIG. 8A shows a table of results of the word error rate from Wall Street Journal (WSJ) dataset when trained using various augmented training sets.

FIG. 8B shows the training curve of baseline and regularized models for training and validation loss on the WSJ dataset, where one curve set shows the learning curve from the baseline model, and the second curve set shows the loss when regularizations are applied.

FIG. 9A shows a table of results for the word error rate on the Libri Speech dataset, in accordance with one or more implementations of the technology disclosed.

FIG. 9B shows a table of word error rate comparison with other end-to-end methods on the WSJ dataset.

FIG. 9C shows a table with the word error rate comparison with other end-to-end methods on Libri Speech dataset.

FIG. 10 is a block diagram of an exemplary system for data augmentation and dropout for the deep neural network based, end-to-end speech recognition model, in accordance with one or more implementations of the technology disclosed.

### DETAILED DESCRIPTION

The following detailed description is made with reference to the figures. Sample implementations are described to illustrate the technology disclosed, not to limit its scope, which is defined by the claims. Those of ordinary skill in the art will recognize a variety of equivalent variations on the description that follows.

Regularization is a process of introducing additional information in order to prevent overfitting. Regularization is important for end-to-end speech models, since the models are highly flexible and easy to over fit. Data augmentation and dropout have been important for improving end-to-end models in other domains. However, they are relatively under explored for end-to-end speech models. That is, regularization has proven crucial to improving the generalization performance of many machine learning models. In particular, regularization is crucial when the model is highly flexible, as is the case with deep neural networks, and likely to over fit on the training data. Data augmentation is an efficient and effective way of doing regularization that introduces very small, or no, overhead during training; and data augmentation has been shown to improve performance in various other pattern recognition tasks.

Generating variations of existing data for training end-to-end speech models has known limitations. For example, in speed perturbation of audio signals, since the pitch is positively related with speed, it is not possible to generate audio with higher pitch but slower speed and vice versa. This limitation reduces the variation potential in augmented data which in turn may hurt performance.

The disclosed technology includes synthesizing sample speech variations on original speech samples, temporally labelled with text transcriptions, to produce multiple sample speech variations that have multiple degrees of variation from the original speech sample and include the temporally labelled text transcription of the original speech sample. For example, to increase variation in the generation of synthetic training data sets, the speed perturbation is separated into two independent components—tempo and pitch. By keeping the pitch and tempo separate, the generated data can cover a wider range of variations. The synthesizing of sample speech data augments audio data through random perturbations of tempo, pitch, volume, temporal alignment, and by adding random noise. The disclosed sample speech variations include modifying a particular original speech sample to independently vary tempo and pitch of the original speech sample while retaining the temporally labelled text transcription of the original speech sample. The resulting thousands to millions of original speech samples and the sample speech variations on the original speech samples can be utilized to train a deep end-to-end speech recognition model that outputs recognized text transcriptions corresponding to speech detected in the original speech samples and the sample speech variations.

Temporally labelled refers to utilizing a time stamp that matches text to segments of the audio. The training data comprises speech samples temporally labeled with ground truth transcriptions. In the context of this application, temporal labeling means annotating time series windows of a speech sample with text labels corresponding to phonemes uttered during the respective time series windows. In one example, for a speech sample that is five seconds long and encodes four phonemes “we love our Labrador” such that the first three phonemes are each uttered over a one-second window and the fourth phoneme is uttered over a two-second window, temporal labeling includes annotating the first second of the speech sample with the ground truth label “we”, the second with “love”, the third second with “our”, and the fourth and fifth seconds with “Labrador”. Concatenating the ground truth labels forms the ground truth transcription “we love our Labrador”; the transcription gets assigned to the speech sample.

Dropout is another powerful way of doing regularization for training deep neural networks, to reduce the co-adaptation among hidden units by randomly zeroing out inputs to the hidden layer during training. The disclosed systems and methods also investigate the effect of dropout applied to the inputs of all layers of the network, as described infra.

The effectiveness of utilizing modified original speech samples for training the mode is compared with published methods for end-to-end trainable, deep speech recognition models. The combination of the disclosed data augmentation and dropout methods give a relative performance improvement on both Wall Street Journal (WSJ) and LibriSpeech datasets of over twenty percent. The disclosed model performance is also competitive with other end-to-end speech models on both datasets. A system for data augmentation and dropout is described next.

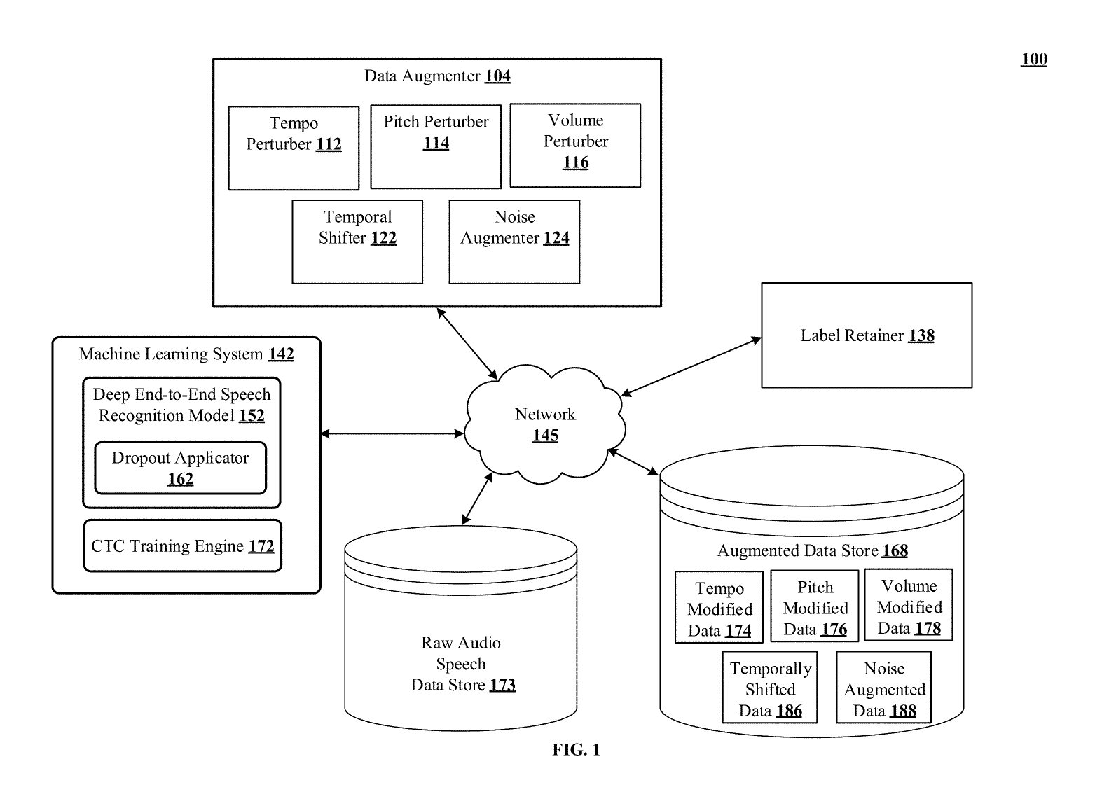

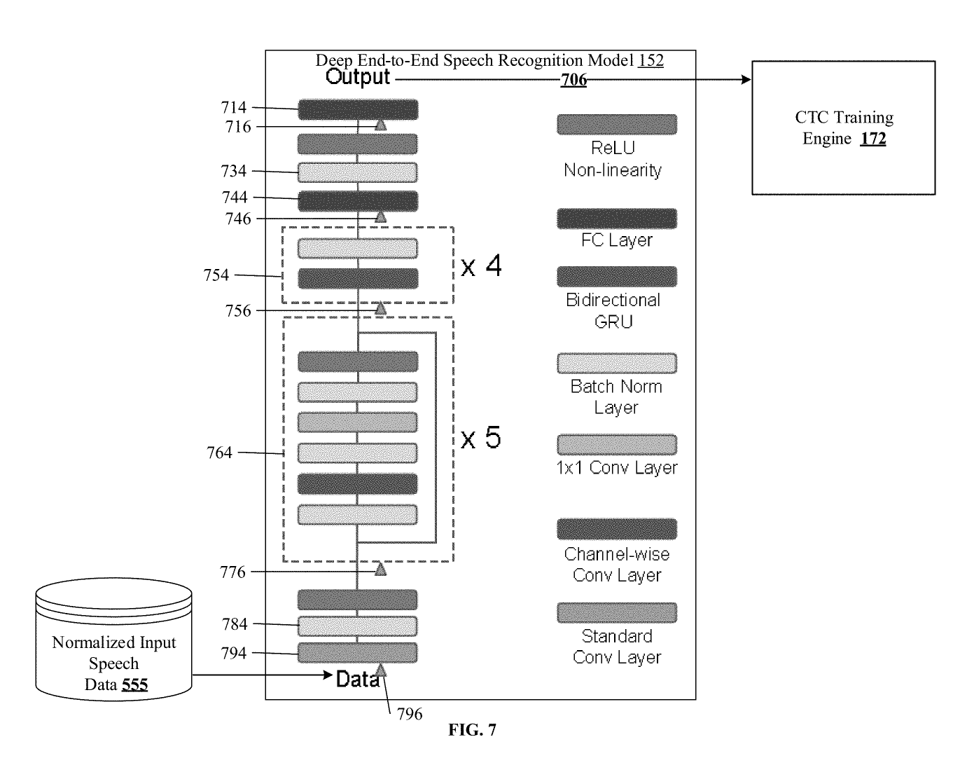

FIG. 1 shows architecture 100 for data augmentation and dropout for deep neural network based, end-to-end speech recognition models. Architecture 100 includes machine learning system 142 with deep end-to-end speech recognition model 152 that includes between one million and five million parameters and dropout applicator 162, and connectionist temporal classification (CTC) training engine 172 described relative to FIG. 7 infra. Architecture 100 also includes raw audio speech data store 173, which includes original speech samples temporally labelled with text transcriptions. In one implementation the samples include the Wall Street Journal (WSJ) dataset and the LibriSpeech dataset—a large, 1000 hour, corpus of English read speech derived from audiobooks in the LibriVox project, sampled at 16 kHz. The accents are various and not marked, but the majority are US English. In another use case, a different set of samples could be utilized as raw audio speech and stored in raw audio speech data store 173.

Architecture 100 additionally includes data augmenter 104 which includes tempo perturber 112 for independently varying the tempo of a speech sample, pitch perturber 114 for independently varying the pitch of an original speech sample, and volume perturber 116 for modifying the particular original speech sample to vary its volume, independently of varying the tempo and the pitch. In one case, tempo perturber 112 can select randomly between a uniform distribution U (0.7, 1.3) to independently vary the tempo of the original speech sample. Data augmenter 104 also includes temporal shifter 122 for applying temporal alignment offsets to the particular original speech sample, thereby producing additional sample speech variations having a further degree of alignment variation from the particular original speech sample and having the temporally labelled text transcription of the original speech sample. In one case, temporal shifter 122 selects at least one alignment parameter between 0 ms and 10 ms to temporally shift the original speech sample. In some cases, pitch perturber 114 can select at least one pitch parameter between a uniform distribution U (−500, 500) to independently vary the pitch of the original speech sample. Volume perturber 116 can select at least one gain parameter between a uniform distribution U (−20, 10) to independently vary the volume of the original speech sample. Data augmenter 104 additionally includes noise augmenter 124 for synthesizing sample speech variations by applying pseudo-random noise to the particular original speech sample, thereby producing additional sample speech variations that have a further degree of signal to noise variation from the particular original speech sample and have the temporally labelled text transcription of the original speech sample. In some cases, the pseudo-random noise is generated from recordings of sound and combined with the original speech sample as random background noise, and selecting at least one signal to noise ratio between 10 db and 15 db to add the pseudo-random noise to the original speech sample. One implementation utilizes SoX sound exchange utility to convert between formats of computer audio files and to apply various effects to these sound files. In another implementation a different audio manipulation tool can be utilized.

Continuing the description of FIG. 1, architecture 100 also includes label retainer 138 for retaining the text transcription for the original speech sample for the tempo modified data 174, pitch modified data 176, volume modified data 178, temporally shifted data 186 and noise augmented data 188—stored in augmented data store 168.

Further continuing the description of FIG. 1, architecture 100 includes network 145 that interconnects the elements of architecture 100: machine learning system 142, data augmenter 104, label retainer 138, raw audio speech data store 173 and augmented data store 168 in communication with each other. The actual communication path can be point-to-point over public and/or private networks. Some items, such as data from data sources, might be delivered indirectly, e.g. via an application store (not shown). The communications can occur over a variety of networks, e.g. private networks, VPN, MPLS circuit, or Internet, and can use appropriate APIs and data interchange formats, e.g. REST, JSON, XML, SOAP and/or JMS. The communications can be encrypted. The communication is generally over a network such as the LAN (local area network), WAN (wide area network), telephone network (Public Switched Telephone Network (PSTN), Session Initiation Protocol (SIP), wireless network, point-to-point network, star network, token ring network, hub network, Internet, inclusive of the mobile Internet, via protocols such as EDGE, 3G, 4G LTE, Wi-Fi and WiMAX. Additionally, a variety of authorization and authentication techniques, such as username/password, OAuth, Kerberos, Secure ID, digital certificates and more, can be used to secure the communications.

FIG. 1 shows an architectural level schematic of a system in accordance with an implementation. Because FIG. 1 is an architectural diagram, certain details are intentionally omitted to improve the clarity of the description.

Moreover, the technology disclosed can be implemented using two or more separate and distinct computer-implemented systems that cooperate and communicate with one another. The technology disclosed can be implemented in numerous ways, including as a process, a method, an apparatus, a system, a device, a computer readable medium such as a computer readable storage medium that stores computer readable instructions or computer program code, or as a computer program product comprising a computer usable medium having a computer readable program code embodied therein.

In some implementations, the elements or components of architecture 100 can be engines of varying types including workstations, servers, computing clusters, blade servers, server farms, or any other data processing systems or computing devices. The elements or components can be communicably coupled to the databases via a different network connection.

While architecture 100 is described herein with reference to particular blocks, it is to be understood that the blocks are defined for convenience of description and are not intended to require a particular physical arrangement of component parts. Further, the blocks need not correspond to physically distinct components. To the extent that physically distinct components are used, connections between components (e.g., for data communication) can be wired and/or wireless as desired. The different elements or components can be combined into single software modules and multiple software modules can run on the same hardware.

The disclosed method for regularizing a deep end-to-end speech recognition model to reduce overfitting and improve generalization includes synthesizing sample speech variations on original speech samples temporally labelled with text transcriptions, including modifying a particular original speech sample to independently vary tempo and pitch of the original speech sample while retaining the temporally labelled text transcription of the original speech sample, thereby producing multiple sample speech variations having multiple degrees of variation from the original speech sample and having the temporally labelled text transcription of the original speech sample. A disclosed data augmenter, for synthesizing sample speech variations at the data level instead of feature level augmentation, is described next.

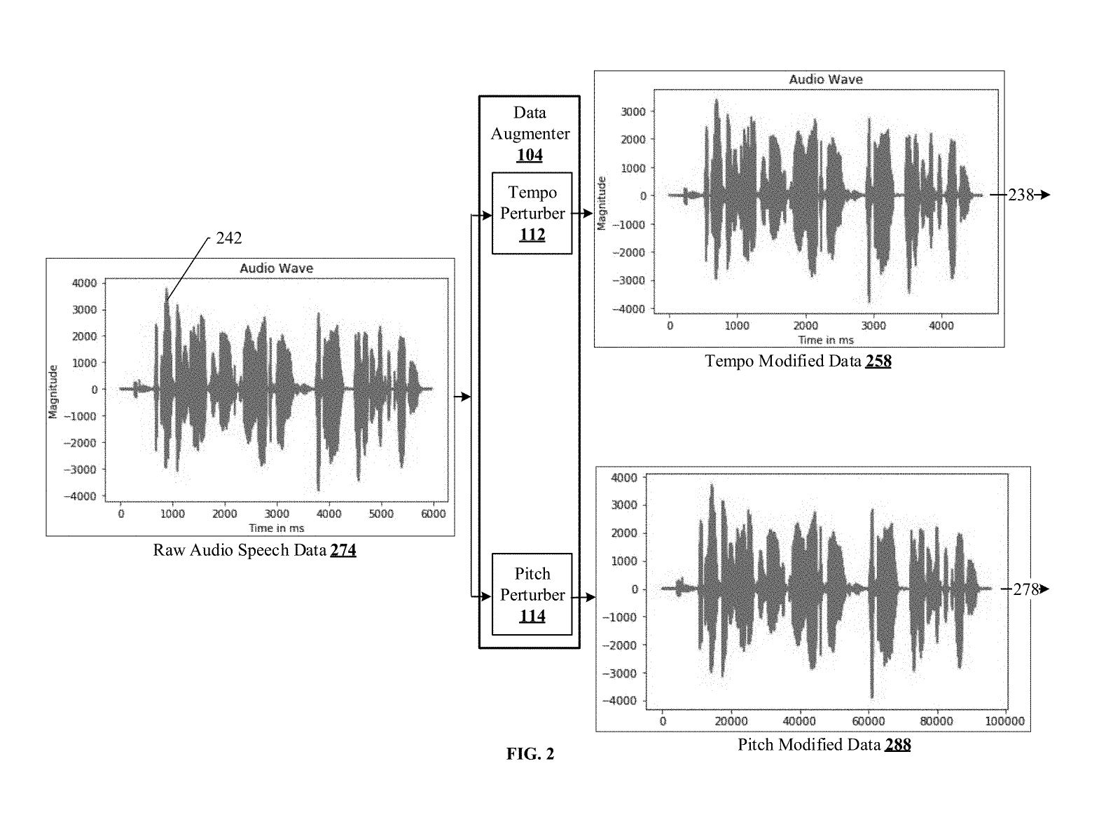

FIG. 2 illustrates a block diagram for data augmenter 104 that synthetically generates a large amount of data that captures different variations. Raw audio speech data 274 is represented by input audio wave 242—the example shown has a duration of 6000 ms (6 seconds) with an amplitude range between (−4000, 4000). The way files store the sampled audio wave using signed integers. To maximize the numerical range, and thus recording quality, the recorded audio has a zero mean, with both positive and negative numerals. There is no unique physical meaning for the absolute number; the relative relationship is the significant representation. In an example continued through the next section, the label, also referred to as the transcript, for the input audio wave 242 is, “A tanker is a ship designed to carry large volumes of oil or other liquid cargo.”

To get increased variation in training data, the speed perturbation is separated into two independent components—tempo and pitch. By keeping the pitch and tempo separate, the data can cover a wider range of variations. Tempo perturber 112 generates tempo perturbed audio wave 238 shown as tempo modified data 258. Due to the increase in tempo, the shortened audio wave 238 in the example is shorter than 5000 ms (5 seconds). A decrease the tempo would result in the generation of a waveform that is longer in time to represent the transcript. Pitch perturber 114 generates pitch perturbed audio wave 278 shown in a graph of pitch modified data 288 with time duration of 100,000 ms (100 seconds).

FIG. 3 continues the block diagram illustration for data augmenter 104 with raw audio speech data 274 represented by input audio wave 242 with label, “A tanker is a ship designed to carry large volumes of oil or other liquid cargo.” Volume perturber 116 generates input audio wave 242 randomly modified to simulate the effect of different recording volumes. Volume perturbed audio wave 338 is shown as volume modified data 358 with an amplitude range between (−7500, 7500) for the example. Data augmenter 104 also includes temporal shifter 122 that generates temporally shifted audio wave 368—selecting at least one alignment parameter between 0 ms and 10 ms to temporally shift the original speech sample. The temporally shifted audio wave 368 is shown in the graph of temporally shifted data 388 for the example.

FIG. 4 continues the block diagram illustration for data augmenter 104 with raw audio speech data 274 represented by input audio wave 242, with label, “A tanker is a ship designed to carry large volumes of oil or other liquid cargo.” Noise augmenter 124 generates noise augmented audio wave 468 by adding white noise, as shown in the graph of noise augmented data 488. Some implementations of noise augmenter 124 include synthesizing sample speech variations by applying pseudo-random noise to the particular original speech sample, thereby producing additional sample speech variations having a further degree of signal to noise variation from the particular original speech sample and having the temporally labelled text transcription of the original speech sample. In one implementation, the pseudo-random noise is generated from recordings of sound and combined with the original speech sample as random background noise. In some cases, noise augmenter 124 selects at least one signal to noise ratio between 10 db and 15 db to add the pseudo-random noise to the original speech sample. One implementation utilizes SoX sound exchange utility, the Swiss Army knife of sound processing programs, to convert between formats of computer audio files and to apply various effects to these sound files. In another implementation a different audio manipulation tool can be utilized.

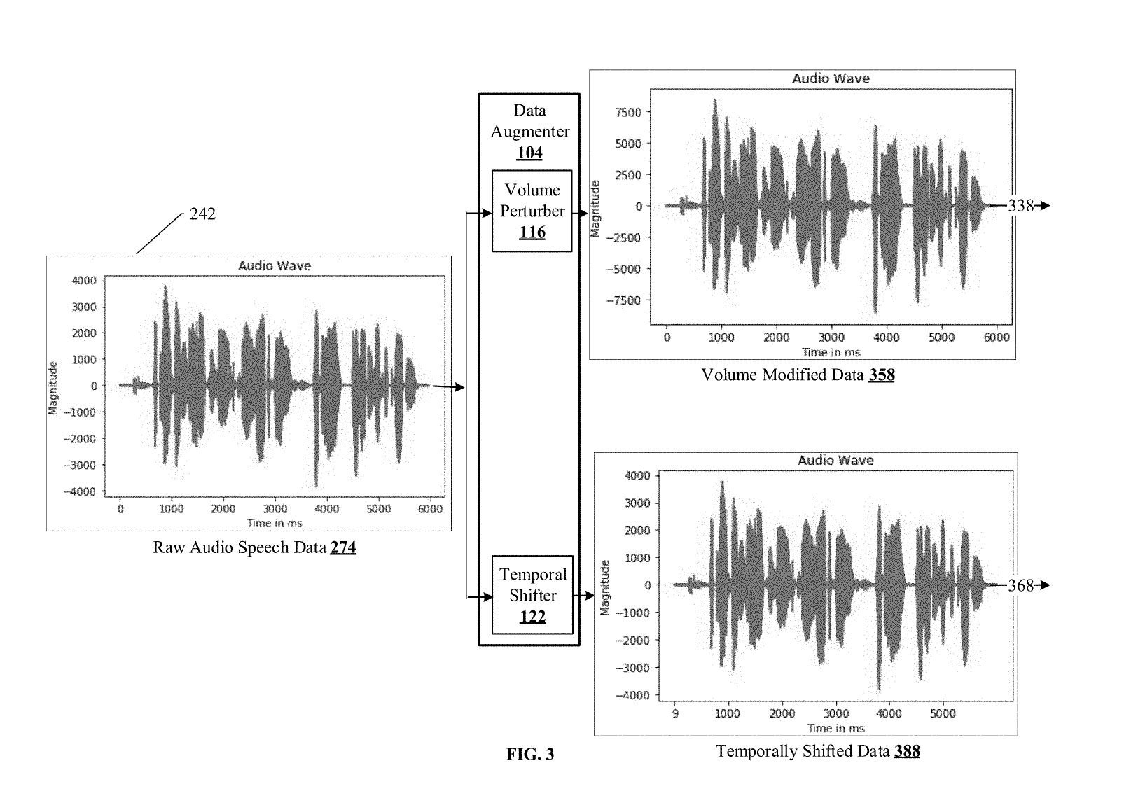

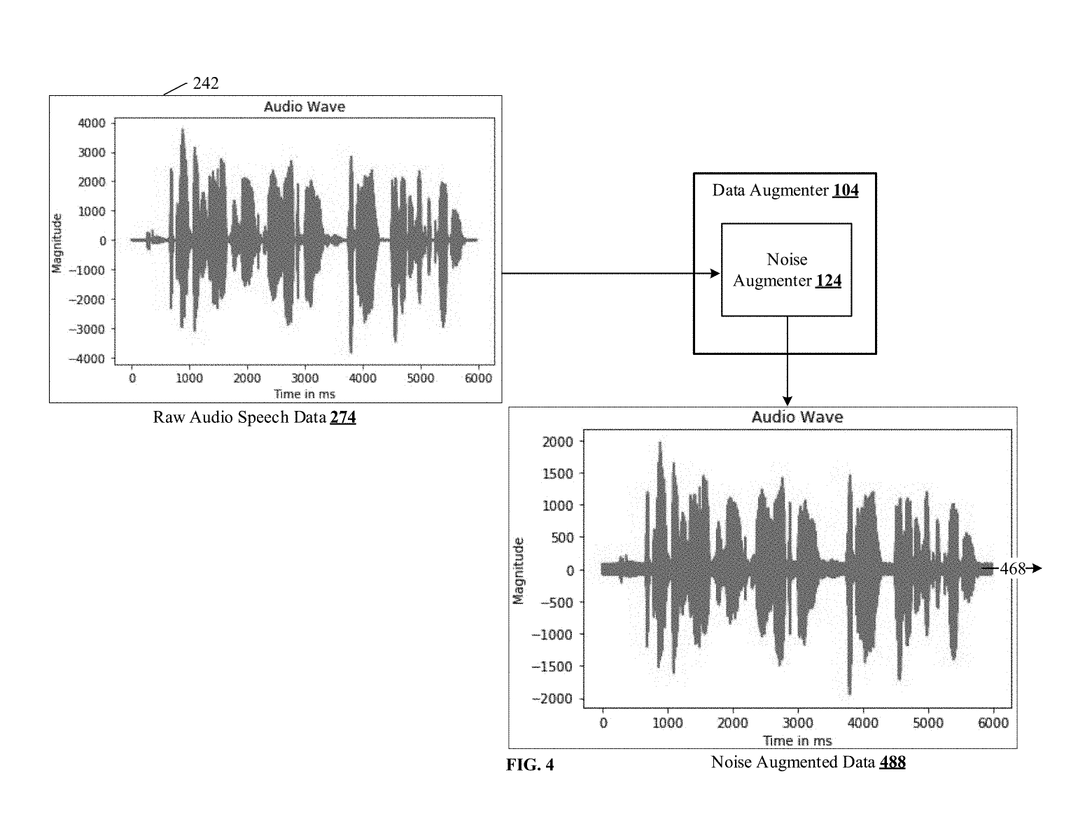

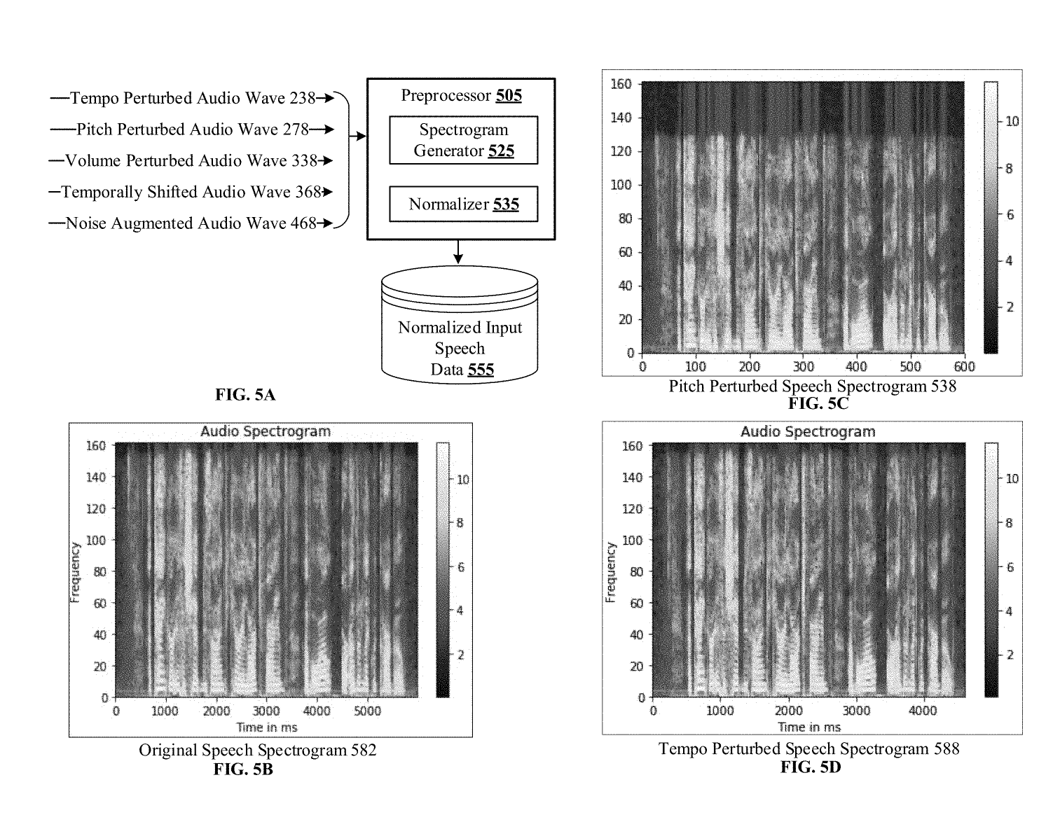

FIG. 5A shows preprocessor 505 that includes spectrogram generator 525 which takes as input tempo perturbed audio wave 238, pitch perturbed audio wave 278, volume perturbed audio wave 338, temporally shifted audio wave 368 and noise augmented audio wave 468 and computes, for each of the input waves, a spectrogram with a 20 ms window and 10 ms step size. The spectrograms show the frequencies that make up the sound—a visual representation of the spectrum of frequencies of sound and how they change over time, from left to right. In the examples shown in the figures, the x axis represents time in ms, the y axis is frequency in Hertz (Hz) and the colors shown on the right side are power per frequency in decibels per Hertz (dB/Hz).

Continuing with FIG. 5A, preprocessor 505 also includes normalizer 535 that normalizes each spectrogram to have zero mean and unit variance, and in addition, normalizes each feature to have zero mean and unit variance based on the training set statistics. Normalization changes only the numerical values inside the spectrogram. Normalizer 535 stores the results in normalized input speech data 555.

FIG. 5B shows the audio spectrogram graph of the original speech spectrogram 582 for input audio wave 242 that represents the transcription, “A tanker is a ship designed to carry large volumes of oil or other liquid cargo.”

FIG. 5C shows the audio spectrogram graph of the pitch perturbed speech spectrogram 538 for the pitch perturbed audio wave 278 that also represents the transcription, “A tanker is a ship designed to carry large volumes of oil or other liquid cargo.” Comparing original speech spectrogram 582 to example pitch perturbed speech spectrogram 538 reveals lower power per frequency in dB/Hz for the pitches above 130 Hz, as represented by the lack of yellow color for those higher frequencies when the pitch has been lowered.

FIG. 5D shows a graph of example tempo perturbed speech spectrogram 588. Note that the time needed to represent the example sentence with label, “A tanker is a ship designed to carry large volumes of oil or other liquid cargo” is less after the tempo of the has been perturbed—in this example, represented on the x axis by a spectrogram just over 4000 ms, in comparison with the original speech spectrogram which required over 5000 ms to represent the sentence.

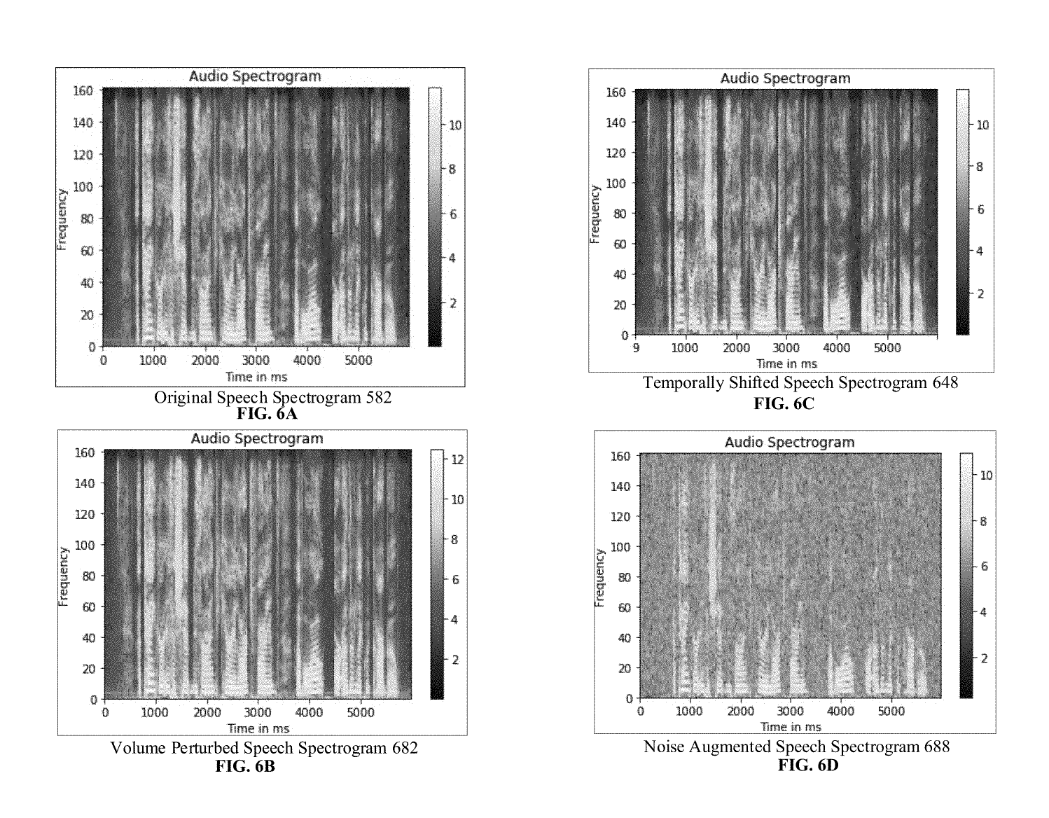

FIG. 6A shows the audio spectrogram graph of the original speech spectrogram 582 for input audio wave 242 that represents the transcription, “A tanker is a ship designed to carry large volumes of oil or other liquid cargo,” as shown in FIG. 5B, for the reader's ease of comparison with FIGS. 6B, 6C and 6D.

FIG. 6B shows a graph of example volume perturbed speech spectrogram 682. Note the increased volume represented by the power per frequency (dB/Hz), as the scale extends to 12 dB/Hz for the example perturbation.

FIG. 6C shows a graph of temporally shifted speech spectrogram 648; the temporal shift of between 0 ms and 10 ms, relative to the original speech sample, is not readily discernable as the scale shown in FIG. 6C covers over 5000 ms.

FIG. 6D shows a graph of example noise augmented speech spectrogram 688. The pseudo-random noise added to the original speech sample via noise augmenter 124 with a noise ratio between 10 db and 15 db for the example sentence with label, “A tanker is a ship designed to carry large volumes of oil or other liquid cargo” is readily visible in noise augmented speech spectrogram 688 in comparison with original speech spectrogram 582.

The disclosed technology includes training a deep end-to-end speech recognition model, on thousands to millions of original speech samples and the sample speech variations on the original speech samples, that outputs recognized text transcriptions corresponding to speech detected in the original speech samples and the sample speech variations. The disclosed model has over five million parameters, making regularization important for the speech recognition model to generalize well. The millions can include less than a billion, and can be five million, ten million, twenty-five million, fifty million seventy-five million or some other number of millions of samples. The model architecture is described next.

FIG. 7 shows the model architecture for deep end-to-end speech recognition model 152 whose full end-to-end model structure is illustrated. Different colored blocks represent different layers, as shown in the legend on the right side of block diagram of the model. First, deep end-to-end speech recognition model 152 uses depth-wise separable convolution for all the convolution layers. The depth-wise separable convolution is implemented by first convolving 794 over the input channel-wise, and then convolving with 1×1 filters with the desired number of channels. Stride size only influences the channel-wise convolution; the following 1×1 convolutions always have stride (subsample) one. Secondly, the model utilizes substitute normal convolution layers with residual network (ResNet) blocks. The residual connections help the gradient flow during training. They have been employed in speech recognition and achieved promising results. For example, a w×h depth-wise separable convolution with n input and m output channels is implemented by first convolving the input channel-wise with its corresponding w×h filters, followed by standard 1×1 convolution with m filters.

Continuing the description of FIG. 7, deep end-to-end speech recognition model 152 is composed of one standard convolution layer 794 that has larger filter size, followed by five residual convolution blocks 764. Convolutional features are then given as input to a 4-layer bidirectional recurrent neural network 754 with gated recurrent units (GRU). Finally, two fully-connected (abbreviated FC) layers 744, 714 take the last hidden RNN layer as input and output the final per-character prediction 706. Batch normalization 784, 734 is applied to all layers to facilitate training.

The size of the convolution layer is denoted by tuple (C, F, T, SF, ST), where C, F, T, SF, and ST denote number of channels, filter size in frequency dimension, filter size in time dimension, stride in frequency dimension and stride in time dimension respectively. The model has one convolutional layer with size (32,41,11,2,2), and five residual convolution blocks of size (32,7,3,1,1), (32,5,3,1,1), (32,3,3,1,1), (64,3,3,2,1), (64,3,3,1,1) respectively. Following the convolutional layers, the model has 4 layers of bidirectional GRU RNNs with 1024 hidden units per direction per layer. Finally the model has one fully connected hidden layer of size 1024 followed by the output layer. The convolutional and fully connected layers are initialized uniformly. The recurrent layer weights are initialized with a uniform distribution U (− 1/32; 1/32).

The model is trained in an end-to-end fashion to maximize the log-likelihood using connectionist temporal classification, using mini-batch stochastic gradient descent with batch size 64, learning rate 0.1, and with Nesterov momentum 0.95. The learning rate is reduced by half whenever the validation loss has plateaued, and the model is trained until the validation loss stops improving. The norm of the gradient is clipped to have a maximum value of 1. For the connectionist temporal classification (CTC), consider an entire neural network to be simply a function that takes in some input sequence of length T and outputs some output sequence y also of length T. As long as one has an objective function on the output sequence y, they can train their network to produce the desired output. The key idea behind CTC is that instead of somehow generating the label as output from the neural network, one instead generates a probability distribution at every time step and can then decode this probability distribution into a maximum likelihood label, and can train the network by creating an objective function that coerces the maximum likelihood decoding for a given input sequence to correspond to the desired label.

Dropout is a powerful regularizer that prevents the coadaptation of hidden units by randomly zeroing out a subset of inputs for that layer during training. To further regularize the model, deep end-to-end speech recognition model 152 employs dropout applicator 162 to apply dropout to each input layer of the network. Triangles 796, 776, 756, 746 and 716 are indicators that dropout happens right before the layer to which the triangle points.

In more detail, let xᵢ^{t} ∈ R^{d} denote the ith input sample to a network layer at time t, dropout does the following to the input during training

zᵢⱼ^{t}˜Bernoulli(1−p) where j ∈ {1,2, . . . d}

Xᵢ^{t}=xᵢ^{t} dot product zᵢ^{t}

where p is the dropout probability, zᵢ^{t}={zᵢ₁^{t}, zᵢ₂^{t} . . . z_{id}^{t}} is the dropout mask for Xᵢ^{t} and dot product denotes elementwise multiplication. At test time, the input is rescaled by 1−p so that the expected pre-activation stays the same as it was at training time. This setup works well for feed forward networks in practice; however, it hardly finds any success when applied to recurrent neural networks. Instead of randomly dropping different dimensions of the input across time, the disclosed method uses a fixed random mask for the input across time. More precisely, the disclosed method modifies the dropout to the input as follows:

zᵢⱼ^{t}˜Bernoulli(1−p) where j ∈ {1,2, . . . d}

Xᵢ^{t}=xᵢ^{t} dot product zᵢ

where z={zᵢ₁, zᵢ₂, . . . z_{id}} is the dropout mask. The disclosed method chooses the same rescaling approximation as standard dropout—that is, rescale input by 1×p at test time, applying the dropout variant described to inputs 796, 776, 756 of all convolutional and recurrent layers. Standard dropout is applied on the fully connected layers 746, 716.

The final per-character prediction 706 output of deep end-to-end speech recognition model 152 is used as input to CTC training engine 172.

FIG. 7 also illustrates the input for the model as normalized input speech data 555 and output 706 to CTC training engine 172. The input to the model is a spectrogram computed with a 20 ms window and 10 ms step size, as described relative to FIG. 5A.

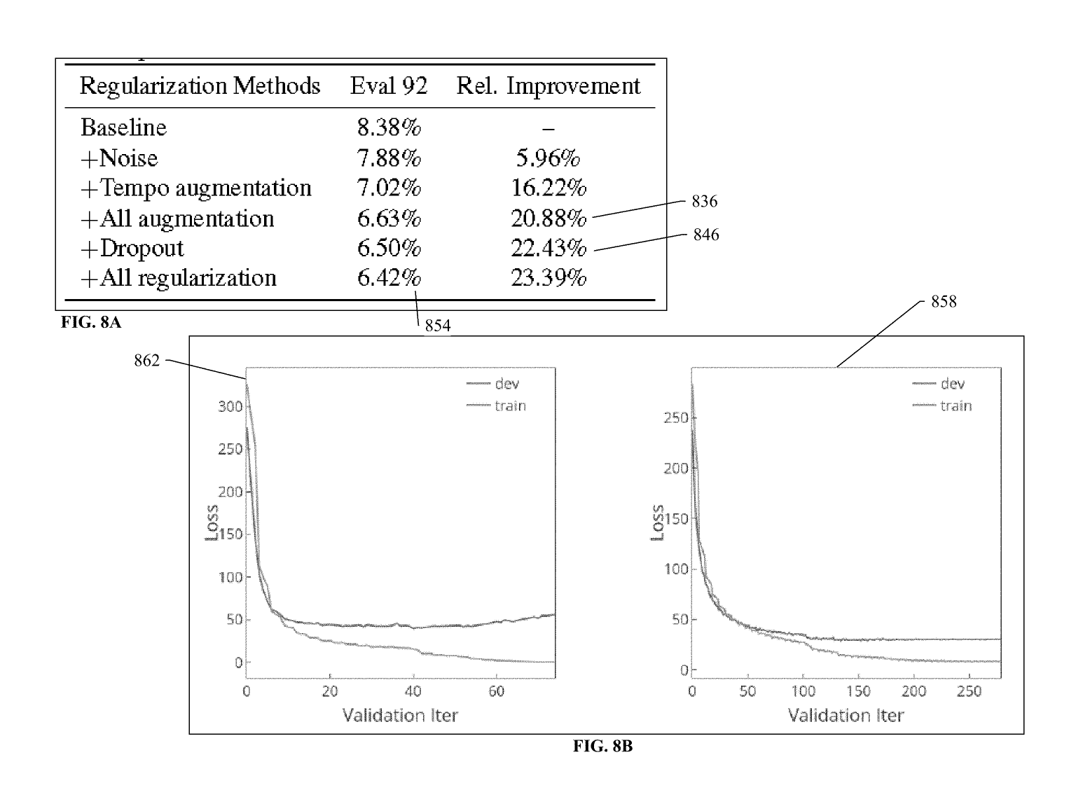

FIG. 8A shows a table of the word error rate results from the WSJ dataset. Baseline denotes the model trained only with weight decay; noise denotes the model trained with noise augmented data; tempo augmentation denotes the model trained with independent tempo and pitch perturbation; all augmentation denotes the model trained with all proposed data augmentations; dropout denotes the model trained with dropout. The experiments are described in more detail next.

Experiments on the Wall Street Journal (WSJ) and LibriSpeech datasets were used to show the effectiveness of the disclosed technology. FIG. 8A shows the results of experiments performed on both datasets with various settings to study the effectiveness of data augmentation and dropout, for the disclosed technology. The first set of experiments were carried out on the WSJ corpus, using the standard si284 set for training, dev93 for validation and eval92 for test evaluation. The provided language model was used and the results were reported in the 20K closed vocabulary setting with beam search. The beam width was set to 100. Since the training set is relatively small (˜80 hours), a more detailed ablation study was performed on this dataset by separating the tempo based augmentation from the one that generates noisy versions of the data. For tempo based data augmentation, the tempo parameter was selected following: a uniform distribution U(0:7; 1:3), and U(−500; 500) for pitch. Since WSJ has relatively clean recordings, the signal to noise ratio was kept between 10 and 15 db when adding white noise. The gain was selected from U(−20; 10) and the audio was shifted randomly by 0 to 10 ms.

FIG. 8A shows the experiment results. Both approaches improved the performance over the baseline, where none of the additional regularization was applied. Noise augmentation has demonstrated its effectiveness for making the model more robust against noisy inputs. Adding a small amount of noise also benefits the model on relatively clean speech samples. To compare with existing augmentation methods, a model was trained using speed perturbation with 0.9, 1.0, and 1.1 as the perturb coefficient for speed. This results in a word error rate (WER) of 7.21%, which brings 13.96% relative performance improvement. The disclosed tempo based augmentation is slightly better than the speed augmentation, which may be attributed to more variations in the augmented data. When the techniques for data augmentation are combined, the result is a significant relative improvement of 20% over the baseline 836.

Additionally, FIG. 8A shows that dropout also significantly improved the performance: 22% relative improvement 846. The dropout probabilities are set as follows: 0.1 for data, 0.2 for all convolution layers, 0.3 for all recurrent and fully connected layers. By combining all regularization, the disclosed final word error rate (WER) achieved was 6:42% 854.

FIG. 8B shows the training curve of baseline and regularized models for training and validation loss on the Wall Street Journal (WSJ) dataset, in which one curve set 862 shows the learning curve from the baseline model, and the second curve set 858 shows the loss when regularizations are applied. The curves illustrate that with regularization, the gap between the validation and training loss is narrowed. In addition, the regularized training also results in a lower validation loss.

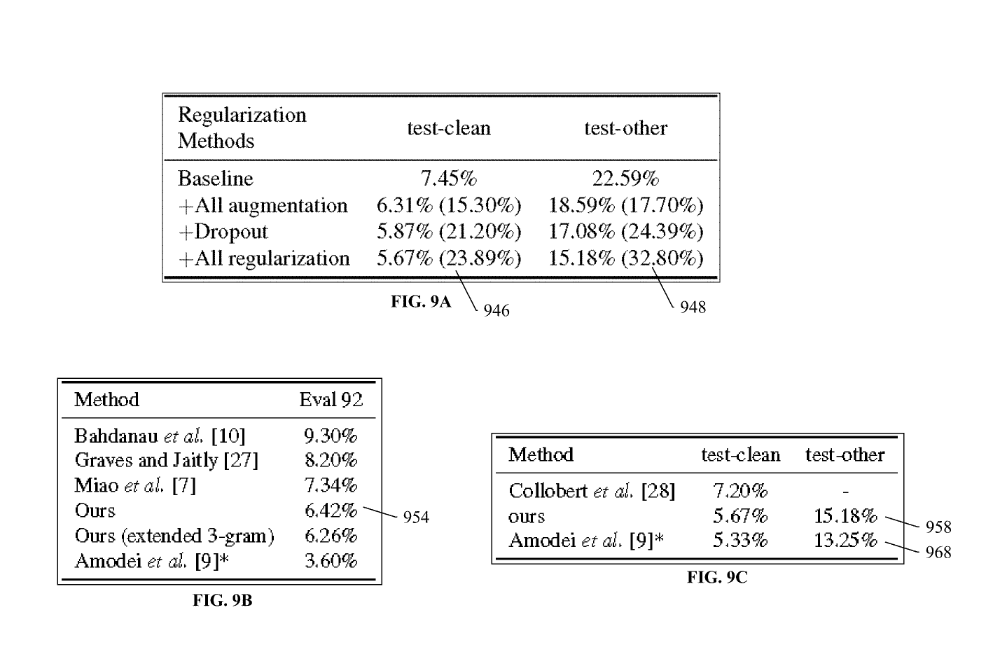

FIG. 9A shows a table of results of experiments performed on the LibriSpeech dataset, with the model trained using all 960 hours of training data. Both dev-clean and dev-other were used for validation and results are reported on test-clean and test-other. The provided 4-gram language model is used for final beam search decoding. The beam width used in this experiment is also set to 100. The table in FIG. 9A shows the word error rate on the LibriSpeech dataset, with numbers in parentheses indicating relative performance improvement over baseline. The results follow a similar trend as the previous experiments, with the disclosed technology achieving a relative performance improvement of over 23% on test-clean 946 and over 32% on test-other set 948.

For a comparison to other methods, the results from WSJ and LibriSpeech were obtained through beam search decoding with the language model provided with the dataset with beam size 100. To make a fair comparison on the WSJ corpus, an extended trigram model was additionally trained with the data released with the corpus. The disclosed results on both WSJ and LibriSpeech are competitive to existing methods. FIG. 9B is a table of word error rate comparison of the results for the disclosed technology 954 with other end-to-end methods on the WSJ dataset.

FIG. 9C shows a table of the word error rate comparison with other end-to-end methods on LibriSpeech dataset. Note that the disclosed model with variations in training achieved results 958 comparable to the results of Amodei et al. 968 on LibriSpeech dataset, even though the disclosed model was only trained only on the provided training set. These results demonstrate the effectiveness of the disclosed regularization methods for training end-to-end speech models.

### Computer System

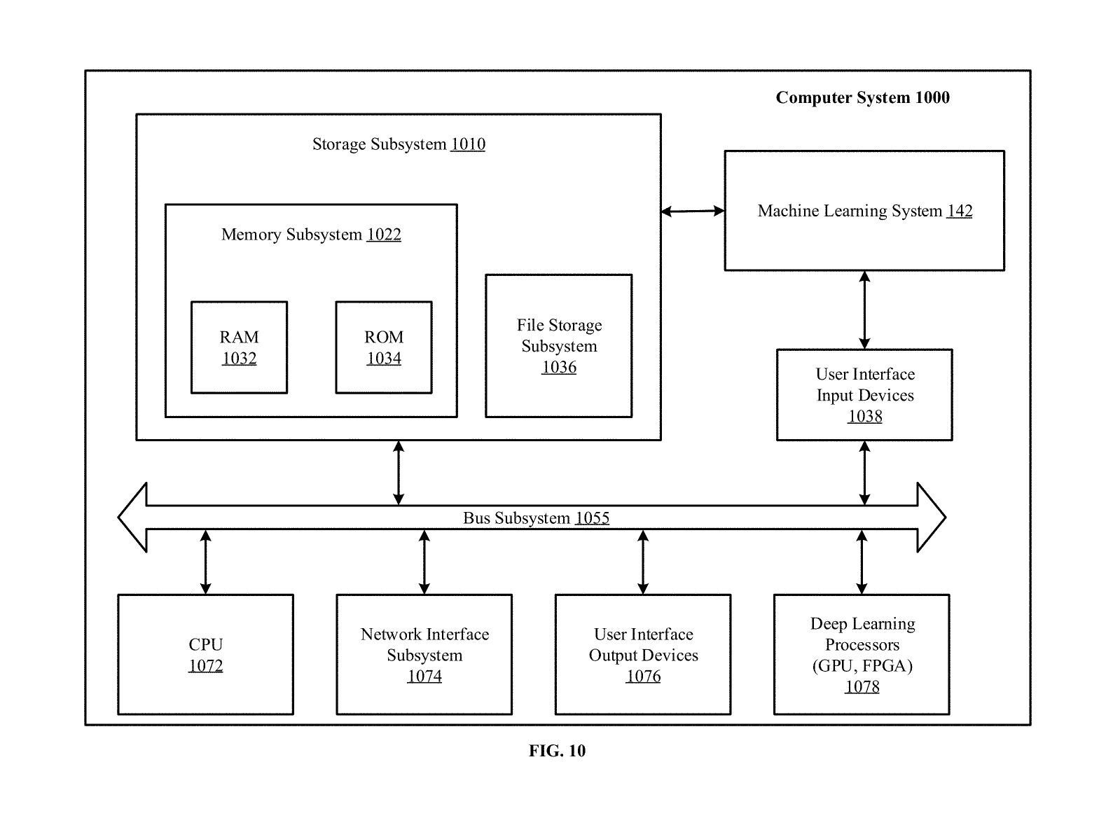

FIG. 10 is a simplified block diagram of a computer system 1000 that can be used to implement the machine learning system 142 of FIG. 1 for regularizing a deep end-to-end speech recognition model to reduce overfitting and improve generalization. Computer system 1000 includes at least one central processing unit (CPU) 1072 that communicates with a number of peripheral devices via bus subsystem 1055. These peripheral devices can include a storage subsystem 1010 including, for example, memory devices and a file storage subsystem 1036, user interface input devices 1038, user interface output devices 1076, and a network interface subsystem 1074. The input and output devices allow user interaction with computer system 1000. Network interface subsystem 1074 provides an interface to outside networks, including an interface to corresponding interface devices in other computer systems.

In one implementation, the machine learning system 142 of FIG. 1 is communicably linked to the storage subsystem 1010 and the user interface input devices 1038.

User interface input devices 1038 can include a keyboard; pointing devices such as a mouse, trackball, touchpad, or graphics tablet; a scanner; a touch screen incorporated into the display; audio input devices such as voice recognition systems and microphones; and other types of input devices. In general, use of the term “input device” is intended to include all possible types of devices and ways to input information into computer system 1000.

User interface output devices 1076 can include a display subsystem, a printer, a fax machine, or non-visual displays such as audio output devices. The display subsystem can include an LED display, a cathode ray tube (CRT), a flat-panel device such as a liquid crystal display (LCD), a projection device, or some other mechanism for creating a visible image. The display subsystem can also provide a non-visual display such as audio output devices. In general, use of the term “output device” is intended to include all possible types of devices and ways to output information from computer system 1000 to the user or to another machine or computer system.

Storage subsystem 1010 stores programming and data constructs that provide the functionality of some or all of the modules and methods described herein. These software modules are generally executed by deep learning processors 1078.

Deep learning processors 1078 can be graphics processing units (GPUs) or field-programmable gate arrays (FPGAs). Deep learning processors 1078 can be hosted by a deep learning cloud platform such as Google Cloud Platform™, Xilinx™, and Cirrascale™. Examples of deep learning processors 1078 include Google's Tensor Processing Unit (TPU)™, rackmount solutions like GX4 Rackmount Series™, GX8 Rackmount Series™, NVIDIA DGX-1™, Microsoft' Stratix V FPGA™, Graphcore's Intelligent Processor Unit (IPU)™, Qualcomm's Zeroth Platform™ with Snapdragon processors™, NVIDIA's Volta™, NVIDIA's DRIVE PX™, NVIDIA's JETSON TX1/TX2 MODULE™, Intel's Nirvana™, Movidius VPU™, Fujitsu DPI™, ARM's DynamicIQ™, IBM TrueNorth™, and others.

Memory subsystem 1022 used in the storage subsystem 1010 can include a number of memories including a main random access memory (RAM) 1032 for storage of instructions and data during program execution and a read only memory (ROM) 1034 in which fixed instructions are stored. A file storage subsystem 1036 can provide persistent storage for program and data files, and can include a hard disk drive, a floppy disk drive along with associated removable media, a CD-ROM drive, an optical drive, or removable media cartridges. The modules implementing the functionality of certain implementations can be stored by file storage subsystem 1036 in the storage subsystem 1010, or in other machines accessible by the processor.

Bus subsystem 1055 provides a mechanism for letting the various components and subsystems of computer system 1000 communicate with each other as intended. Although bus subsystem 1055 is shown schematically as a single bus, alternative implementations of the bus subsystem can use multiple busses.

Computer system 1000 itself can be of varying types including a personal computer, a portable computer, a workstation, a computer terminal, a network computer, a television, a mainframe, a server farm, a widely-distributed set of loosely networked computers, or any other data processing system or user device. Due to the ever-changing nature of computers and networks, the description of computer system 1000 depicted in FIG. 10 is intended only as a specific example for purposes of illustrating the preferred embodiments of the present invention. Many other configurations of computer system 1000 are possible having more or less components than the computer system depicted in FIG. 10.

The preceding description is presented to enable the making and use of the technology disclosed. Various modifications to the disclosed implementations will be apparent, and the general principles defined herein may be applied to other implementations and applications without departing from the spirit and scope of the technology disclosed. Thus, the technology disclosed is not intended to be limited to the implementations shown, but is to be accorded the widest scope consistent with the principles and features disclosed herein. The scope of the technology disclosed is defined by the appended claims.

### Some Particular Implementations

Some particular implementations and features are described in the following discussion.

In one implementation, a disclosed computer-implemented method of regularizing a deep end-to-end speech recognition model to reduce overfitting and improve generalization, includes synthesizing sample speech variations on original speech samples, the original speech samples including labelled audio samples matched in time with text transcriptions, the synthesizing including modifying a particular original speech sample to independently vary tempo and pitch of the original speech sample while retaining labeling with the text transcription, thereby producing multiple sample speech variations having multiple degrees of variation from the original speech sample and labelled with the text transcription of the original speech sample; and training a deep end-to-end speech recognition model, on the original speech samples and the sample speech variations on the original speech samples, in one thousand to millions of backward propagation iterations, so that the deep end-to-end speech recognition model outputs recognized text transcriptions corresponding to speech detected.

In another implementation, a disclosed computer-implemented method of regularizing a deep end-to-end speech recognition model to reduce overfitting and improve generalization, includes synthesizing sample speech variations on original speech samples temporally labelled with text transcriptions, including modifying a particular original speech sample to independently vary tempo and pitch of the original speech sample while retaining the temporally labelled text transcription of the original speech sample, thereby producing multiple sample speech variations having multiple degrees of variation from the original speech sample and having the temporally labelled text transcription of the original speech sample; and training a deep end-to-end speech recognition model, on thousands to millions of original speech samples and the sample speech variations on the original speech samples, that outputs recognized text transcriptions corresponding to speech detected in the original speech samples and the sample speech variations. A speech sample comprises a single waveform that encodes an utterance. When an utterance is encoded over two waveforms, it forms two speech samples.

This method and other implementations of the technology disclosed can include one or more of the following features and/or features described in connection with additional methods disclosed. In the interest of conciseness, the combinations of features disclosed in this application are not individually enumerated and are not repeated with each base set of features.

One implementation of the disclosed method further includes synthesizing sample speech variations by further modifying the particular original speech sample to vary its volume, independently of varying the tempo and the pitch, thereby producing additional sample speech variations having a further degree of gain variation from the particular original speech sample and having the labelled text transcription of the original speech sample. In this context, higher volumes increase the gain and lower volumes decrease the gain, when applied to the original speech sample, resulting in a “further degree of gain variation”.

Another implementation of the disclosed method further includes synthesizing sample speech variations by applying temporal alignment offsets to the particular original speech sample, thereby producing additional sample speech variations having a further degree of alignment variation from the particular original speech sample and having the labelled text transcription of the original speech sample. Further degree of alignment variation can include a shift of the alignment between the original speech sample and the sample speech variation with temporal alignment offset of zero milliseconds to ten milliseconds. That is, the disclosed method can further include selecting at least one alignment parameter between 0 ms and 10 ms to temporally shift the original speech sample.

Some implementations of the disclosed method further include synthesizing sample speech variations by applying pseudo-random noise to the particular original speech sample, thereby producing additional sample speech variations having a further degree of signal to noise variation from the particular original speech sample and having the labelled text transcription of the original speech sample. In some cases, the pseudo-random noise is generated from recordings of sound and combined with the original speech sample as random background noise. The disclosed method can further include selecting at least one signal to noise ratio between ten decibels and fifteen decibels to add the pseudo-random noise to the original speech sample. This is referred to as having a further degree of signal to noise variation from the original speech sample.

In one implementation of the disclosed method, the training further includes a forward pass stage which analyzes the original speech samples and the sample speech variations using the model that outputs the recognized text transcriptions; a backward pass stage which reduces errors in the recognized text transcriptions as compared to the labelled text transcriptions of the original speech samples and the sample speech variations; and a persistence stage which persists coefficients learned during the training with the model to be applied to further end-to-end speech recognition.

Some implementations of the disclosed method further include selecting at least one tempo parameter between a uniform distribution U (0.7, 1.3) to independently vary the tempo of the original speech sample.

Other implementations of the disclosed method further include selecting at least one pitch parameter between a uniform distribution U (−500, 500) to independently vary the pitch of the original speech sample. The disclosed method can include selecting at least one gain parameter between a uniform distribution U (−20, 10) to independently vary the volume of the original speech sample.

The disclosed model has between one million and five million parameters. Some implementations of the disclosed method further include regularizing the model by applying variant dropout to inputs of convolutional and recurrent layers of the model. The recurrent layers of this system can include LSTM layers, GRU layers, residual blocks, and/or batch normalization layers.

One implementation of a disclosed speech recognition system includes a regularized deep end-to-end speech recognition model, running on numerous parallel cores, trained on original speech samples and sample speech variations on the original speech samples, wherein the sample speech variations comprise tempo modified sample speech variations synthesized by independently varying tempo of the original speech samples, pitch modified sample speech variations synthesized by independently varying pitch of the original speech samples, volume modified sample speech variations synthesized by independently varying volume of the original speech samples, temporally shifted sample speech variations synthesized by temporally shifting the original speech samples, and noise augmented sample speech variations synthesized by adding pseudo-random noise to the original speech samples. The disclosed system includes an input stage of the trained model, running on at least one of the parallel cores, that feeds thousands to millions of original speech samples and the sample speech variations on the original speech samples to the trained model for evaluation; and an output stage of the trained model, running on at least one of the parallel cores, that translates evaluation by the trained model into recognized text transcriptions corresponding to speech detected in the original speech samples and the sample speech variations.

In another implementation, a disclosed system for regularizing a deep end-to-end speech recognition model to reduce overfitting and improve generalization comprising a data augmenter for synthesizing sample speech variations on original speech samples labelled with text transcriptions, wherein the data augmenter further comprises a tempo perturber for independently varying tempo of the original speech samples to produce tempo modified sample speech variations and a pitch perturber for independently varying pitch of the original speech samples to produce pitch modified sample speech variations; a label retainer for labelling the sample speech variations with text transcriptions of respective original speech samples; and a trainer for training a deep end-to-end speech recognition model, on thousands to millions of labelled sample speech samples and original speech variations, that outputs recognized text transcriptions corresponding to speech detected in the labelled sample speech samples and original speech variations.

In one implementation of the disclosed system, the data augmenter further comprises a volume perturber for independently varying volume of the original speech samples to produce volume modified sample speech variations. In some cases, the data augmenter further comprises an aligner for temporally shifting the original speech samples to produce temporally shifted sample speech variations. In other implementations, the data augmenter further comprises a noise augmenter for adding pseudo-random noise to the original speech samples to produce noise augmented sample speech variations.

In another implementation, a disclosed system includes one or more processors coupled to memory, the memory loaded with computer instructions to regularize a deep end-to-end speech recognition model and thereby reducing overfitting and improving generalization. The instructions, when executed on the processors, implement actions of the disclosed method described supra.

This system implementation and other systems disclosed optionally include one or more of the features described in connection with methods disclosed. In the interest of conciseness, alternative combinations of system features are not individually enumerated. Features applicable to systems, methods, and articles of manufacture are not repeated for each statutory class set of base features. The reader will understand how features identified in this section can readily be combined with base features in other statutory classes.

In yet another implementation a disclosed tangible non-transitory computer readable storage medium impressed with computer program instructions to regularize a deep end-to-end speech recognition model and thereby reducing overfitting and improving generalization. The instructions, when executed on a processor, implement the disclosed method described supra.

The technology disclosed can be practiced as a system, method, or article of manufacture. One or more features of an implementation can be combined with the base implementation. Implementations that are not mutually exclusive are taught to be combinable. One or more features of an implementation can be combined with other implementations. This disclosure periodically reminds the user of these options. Omission from some implementations of recitations that repeat these options should not be taken as limiting the combinations taught in the preceding sections—these recitations are hereby incorporated forward by reference into each of the following implementations.

The terms and expressions employed herein are used as terms and expressions of description and not of limitation, and there is no intention, in the use of such terms and expressions, of excluding any equivalents of the features shown and described or portions thereof. In addition, having described certain implementations of the technology disclosed, it will be apparent to those of ordinary skill in the art that other implementations incorporating the concepts disclosed herein can be used without departing from the spirit and scope of the technology disclosed. Accordingly, the described implementations are to be considered in all respects as only illustrative and not restrictive.

While the technology disclosed is disclosed by reference to the preferred embodiments and examples detailed above, it is to be understood that these examples are intended in an illustrative rather than in a limiting sense. It is contemplated that modifications and combinations will readily occur to those skilled in the art, which modifications and combinations will be within the spirit of the innovation and the scope of the following claims.

We claim as follows:

1. A computer-implemented method of regularizing a deep end-to-end speech recognition model to reduce overfitting and improve generalization, the method including:
synthesizing sample speech variations on original speech samples, the original speech samples including labelled audio samples matched in time with text transcriptions, the synthesizing including modifying a particular original speech sample to independently vary tempo and pitch of the original speech sample while retaining labeling with the text transcription, thereby producing multiple sample speech variations having multiple degrees of variation from the original speech sample and labelled with the text transcription of the original speech sample; and
training a deep end-to-end speech recognition model, on the original speech samples and the sample speech variations on the original speech samples, in one thousand to millions of backward propagation iterations, so that the deep end-to-end speech recognition model outputs recognized text transcriptions corresponding to speech detected.

2. The computer-implemented method of claim 1, further including synthesizing sample speech variations by further modifying the particular original speech sample to vary its volume, independently of varying the tempo and the pitch, thereby producing additional sample speech variations having a further degree of gain variation from the particular original speech sample and having the labelled text transcription of the original speech sample.

3. The computer-implemented method of claim 1, further including synthesizing sample speech variations by applying temporal alignment offsets to the particular original speech sample, thereby producing additional sample speech variations having a further degree of alignment variation from the particular original speech sample and having the labelled text transcription of the original speech sample.

4. The computer-implemented method of claim 3, further including selecting at least one alignment parameter between zero milliseconds and ten milliseconds to temporally shift the original speech sample.

5. The computer-implemented method of claim 1, further including synthesizing sample speech variations by applying pseudo-random noise to the particular original speech sample, thereby producing additional sample speech variations having a further degree of signal to noise variation from the particular original speech sample and having the labelled text transcription of the original speech sample.

6. The computer-implemented method of claim 5, wherein the pseudo-random noise is generated from recordings of sound and combined with the original speech sample as random background noise.

7. The computer-implemented method of claim 5, further including selecting at least one signal to noise ratio between ten decibels and fifteen decibels to add the pseudo-random noise to the original speech sample.

8. The computer-implemented method of claim 1, wherein the training further includes:
a forward pass stage which analyzes the original speech samples and the sample speech variations using the model that outputs the recognized text transcriptions;
a backward pass stage which reduces errors in the recognized text transcriptions as compared to the labelled text transcriptions of the original speech samples and the sample speech variations; and
a persistence stage which persists coefficients learned during the training with the model to be applied to further end-to-end speech recognition.

9. The computer-implemented method of claim 1, further including selecting at least one tempo parameter between a uniform distribution U (0.7, 1.3) to independently vary the tempo of the original speech sample.

10. The computer-implemented method of claim 1, further including selecting at least one pitch parameter between a uniform distribution U (−500, 500) to independently vary the pitch of the original speech sample.

11. The computer-implemented method of claim 2, further including selecting at least one gain parameter between a uniform distribution U (−20, 10) to independently vary the volume of the original speech sample.

12. The computer-implemented method of claim 1, wherein the model has between one million and five million parameters.

13. The computer-implemented method of claim 1, further including regularizing the model by applying variant dropout to inputs of convolutional and recurrent layers of the model.

14. A speech recognition system, comprising:
a regularized deep end-to-end speech recognition model, running on numerous parallel cores, trained on original speech samples and sample speech variations on the original speech samples, wherein the sample speech variations comprise tempo modified sample speech variations synthesized by independently varying tempo of the original speech samples, pitch modified sample speech variations synthesized by independently varying pitch of the original speech samples, volume modified sample speech variations synthesized by independently varying volume of the original speech samples, temporally shifted sample speech variations synthesized by temporally shifting the original speech samples, and noise augmented sample speech variations synthesized by adding pseudo-random noise to the original speech samples;
an input stage of the trained model, running on at least one of the parallel cores, that feeds thousands to millions of original speech samples and the sample speech variations on the original speech samples to the trained model for evaluation; and
an output stage of the trained model, running on at least one of the parallel cores, that translates evaluation by the trained model into recognized text transcriptions corresponding to speech detected in the original speech samples and the sample speech variations.

15. A system for regularizing a deep end-to-end speech recognition model to reduce overfitting and improve generalization, the system comprising:
a data augmenter for synthesizing sample speech variations on original speech samples, the original speech samples including labelled audio samples matched in time with text transcriptions, wherein the data augmenter further comprises
a tempo perturber for independently varying tempo of the original speech samples to produce tempo modified sample speech variations, and
a pitch perturber for independently varying pitch of the original speech samples to produce pitch modified sample speech variations;
a label retainer for labelling the sample speech variations with text transcriptions of respective original speech samples; and
a trainer for training a deep end-to-end speech recognition model, on the original speech samples and the sample speech variations on the original speech samples, in one thousand to millions of backward propagation iterations, so that the deep end-to-end speech recognition model outputs recognized text transcriptions corresponding to speech detected.

16. The system of claim 15, wherein the data augmenter further comprises a volume perturber for independently varying volume of the original speech samples to produce volume modified sample speech variations.

17. The system of claim 15, wherein the data augmenter further comprises an aligner for temporally shifting the original speech samples to produce temporally shifted sample speech variations.

18. The system of claim 15, wherein the data augmenter further comprises a noise augmenter for adding pseudo-random noise to the original speech samples to produce noise augmented sample speech variations.

19. A system including one or more processors coupled to memory, the memory loaded with computer instructions to regularize a deep end-to-end speech recognition model and thereby reducing overfitting and improving generalization, the instructions, when executed on the processors, implement actions of method 1.

20. A non-transitory computer readable storage medium impressed with computer program instructions to regularize a deep end-to-end speech recognition model and thereby reducing overfitting and improving generalization, the instructions, when executed on a processor, implement method 1.
